(19) United States
(12) Patent Application Publication
(10) Pub. No.: US 2022/0039579 A1
(43) Pub. Date: Feb. 10, 2022

(54) OBJECT DISPOSING STRUCTURE

(71) Applicant: MING-TIEN PAI, Taichung City (TW)

(72) Inventor: MING-TIEN PAI, Taichung City (TW)

(21) Appl. No.: 17/388,763

(22) Filed: Jul. 29, 2021

(30) Foreign Application Priority Data
Aug. 7, 2020 (TW) 109210253

(51) Int. Cl. A47G 29/087

(52) U.S. Cl. CPC A47G 29/087

(57) ABSTRACT

An object disposing structure is adapted for being disposed with an object. The structure includes a main body, a character unit fixed to the main body and provided with one or more strokes, and a retaining and coupling unit disposed with the main body for retaining and coupling the object in a way that a shape of the object and the character unit are substantially and visually located on a same plane. As soon as the object is coupled with the retaining and coupling unit or after the object is coupled with the retaining and coupling unit for a predetermined period of time, the shape of the object forms a part of the at least one stroke of the character unit to result in that a semantic meaning of the character unit remains unchanged, changes, or becomes a pun, thereby creating interactive fun.

### BACKGROUND OF THE INVENTION

### 1. Field of the Invention

The present invention relates generally to an object disposing structure and more particularly, to an object disposing structure having a character unit. After a desired object is coupled with the object disposing structure, the shape of the object forms a part of the strokes of the character unit in such a way that the semantic meaning of the character unit remains unchanged, or changes, or becomes a pun, thereby creating interactive fun.

### 2. Description of the Related Art

A conventional object disposing structure, such as a hook, is generally composed of a main body on which an object fastening member, such as hook member, is provided for holding an object. The main body may be provided or itself forms texts and/or symbols; however, the texts and/or symbols are not related to the object held by the main body. It will become interesting if the shape of the held object can interact with the texts and/or symbols of the main body to result in that the semantic meaning of the texts and/or symbols remains unchanged, or changes, or becomes a pun.

### SUMMARY OF THE INVENTION

The present invention has been accomplished in view of the above-noted circumstances. It is an objective of the present invention to design an object disposing structure having a character unit. After a desired object is coupled with the object disposing structure, the shape of the object just forms a part of the strokes of the character unit to make that the semantic meaning of the character unit remains unchanged, or changes, or becomes a pun, thereby creating interactive fun.

To attain the above-mentioned objective, the present invention provides an object disposing structure for being disposed with an object. The object disposing structure comprises a main body, a character unit fixed to the main body and provided with one or more strokes, and at least one retaining and coupling unit disposed with the main body for retaining and coupling the object in a way that a shape of the object and the character unit are substantially and visually located on a same plane. As soon as the object is coupled with the retaining and coupling unit or after the object is coupled with the retaining and coupling unit for a predetermined period of time, the shape of the object forms a part of the at least one stroke of the character unit to result in that a semantic meaning of the character unit remains unchanged, changes, or becomes a pun.

### BRIEF DESCRIPTION OF THE DRAWINGS

The present invention will become more fully understood from the detailed description given herein below and the accompanying drawings which are given by way of illustration only, and thus are not limitative of the present invention, and wherein:

FIG. 1 is a schematic view showing an object disposing structure of a first embodiment of the present invention before and after objects (pens) are held thereon;

FIG. 2 is a schematic view showing an object disposing structure of a second embodiment of the present invention before and after objects (chopsticks) are held thereon; and

FIG. 3 s a schematic view showing an object disposing structure of a third embodiment of the present invention before and after an object (seed) are placed thereon for a period of time in various states.

### DETAILED DESCRIPTION OF THE INVENTION

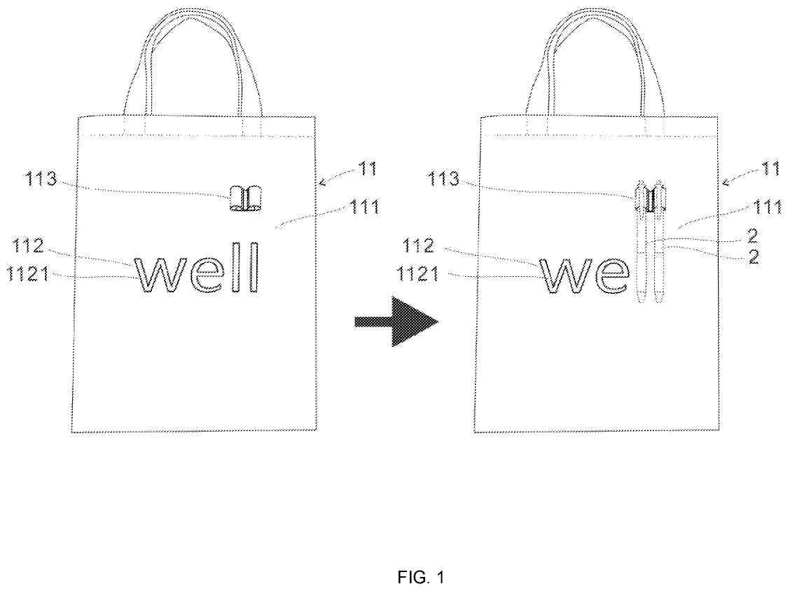

Hereunder three preferred embodiments will be detailedly described with accompanying drawings for illustrating technical features and structure of the present invention. As shown in FIG. 1, an object disposing structure 11 provided in accordance a first embodiment of the present invention is realized as a bag. The object disposing structure 11 is composed of a main body 111, a character unit 112, and two retaining and coupling units 113. The main body 111 is a bag body having handles.

The character unit 112 is fixedly provided at the front side of the main body 111 by printing, adhesion, or other feasible ways, and composed of a plurality of strokes 1121. In this embodiment, the character unit 112 is realized as, but not limited to, a word “well”. It is to be mentioned that the term “character unit” used in the specification and claims of the present invention is directed to one or more semiotic signs, symbols, glyphs or the like, namely one or more letters, numerical digits, ideograms, hieroglyphs, punctuation marks, another typographic marks, etc.

The two retaining and coupling units 113 is fixed mounted to the main body 111 by stitching, adhesion, or other feasible ways for retaining and coupling two objects 2, such as pens, in such a way that the shapes of the objects 2 and the character unit 112 are substantially and visually located on a same plane. As a result, as soon as the objects 2 are coupled with the retaining and coupling unit 113, the shapes of the objects 2 form a part of the strokes of the character unit 112, i.e., characters “11”, such that the semantic meaning of the character unit 112 remains unchanged.

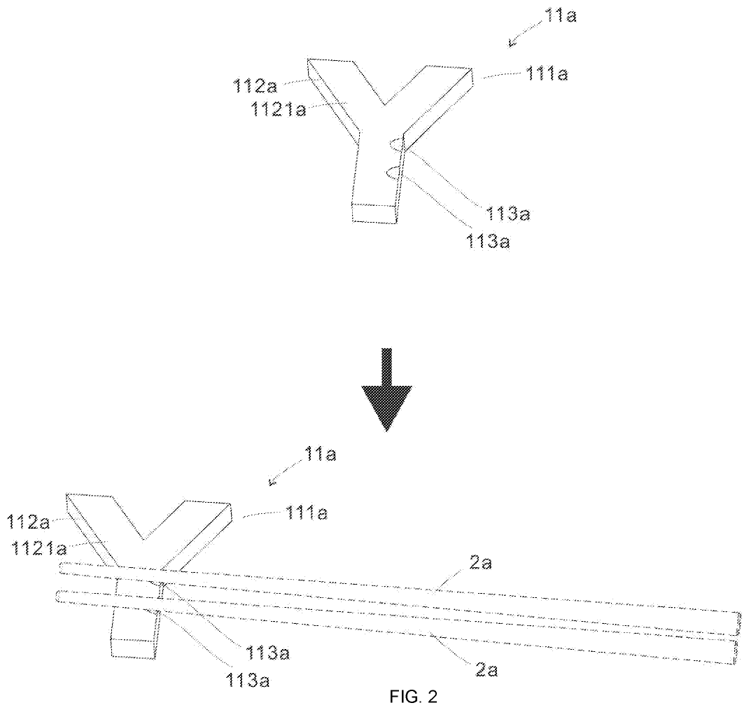

Referring to FIG. 2, an object disposing structure 11a provided in accordance a second embodiment of the present invention is realized as a chopstick holder. The object disposing structure 11a is composed of a main body 111a, a character unit 112a monolithically formed with the main body 111a, and two retaining and coupling units 113a. In this embodiment, the main body 111a and the character unit 112a are monolithically formed as a unity comprising a plurality of strokes 1121a, which are realized as, but not limited to, an uppercase character “Y”. The two retaining and coupling units 113a are formed by two notches recessed on the surface of the main body 111a for retaining and coupling two objects 2a, such as chopsticks. As soon as the objects (chopsticks) 2a are coupled with the retaining and coupling unit 113a, the shapes of the objects 2a just form a part of the strokes 1121a of the character unit 112a, i.e., form a symbol “¥” with the character unit 112a such that the semantic meaning of the character unit 112a changes.

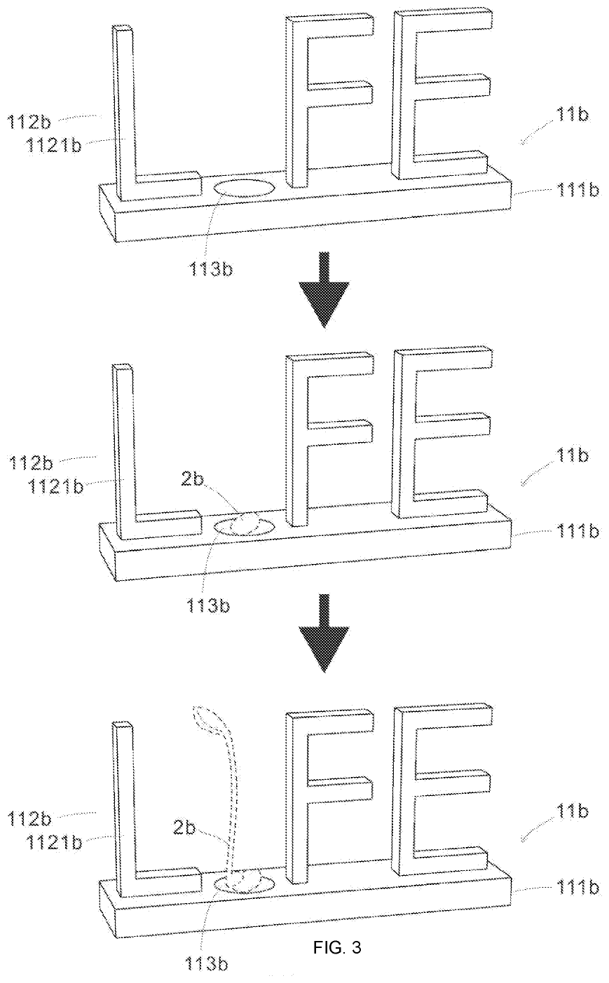

Referring to FIG. 3, an object disposing structure 11b provided in accordance a third embodiment of the present invention is realized as a table decoration. The object disposing structure 11b is composed of a main body 111b, a character unit 112b standing on the main body 111b, and a retaining and coupling unit 113b monolithically formed with the main body 111b. The character unit 112b comprises a plurality of strokes 1121b, which are realized as, but not limited to, characters “L_FE”. The retaining and coupling unit 113b are formed by a notch recessed on the surface of the main body 111b for retaining and coupling an object 2b, such as a seed. After the object (seed) 2b is placed in the retaining and coupling unit 113b for a period of time, the shape of the germination of the object (seed) 2b just forms a part of the strokes 1121b of the character unit 112b, i.e., form a word “LIFE” with the character unit 112b, such that the semantic meaning of the character unit 112b changes.

With the above-mentioned structure features, the present invention can achieve the objective of having interactive fun.

What is claimed is:

1. An object disposing structure for being disposed with an object, the object disposing structure comprising:
a main body;
a character unit fixed to the main body and provided with at least one stroke; and
at least one retaining and coupling unit disposed with the main body for retaining and coupling the object in a way that a shape of the object and the character unit are substantially and visually located on a same plane, and as soon as the object is coupled with the at least one retaining and coupling unit or after the object is coupled with the at least one retaining and coupling unit for a predetermined period of time, the shape of the object forms a part of the at least one stroke of the character unit to result in that a semantic meaning of the character unit remains unchanged, changes, or becomes a pun.

2. The object disposing structure as claimed in claim 1, wherein the character unit is monolithically formed with the main body.

3. The object disposing structure as claimed in claim 1, wherein the at least one fastening and coupling unit is monolithically formed with the main body.
